(19) United States
(12) Patent Application Publication
(10) Pub. No.: US 2014/0352416 A1
(43) Pub. Date: Dec. 4, 2014

(54) DEVICE AND METHOD FOR FAULT DETECTION IN A FUEL SUPPLY SYSTEM OF A MOTOR VEHICLE

(71) Applicant: SCANIA CV AB, Södertälje (SE)

(72) Inventors: Rikard Dyrsch, Södertälje (SE); Erik Rundqvist, Stockholm (SE)

(21) Appl. No.: 14/364,172

(22) PCT Filed: Dec. 10, 2012
(86) PCT No.: PCT/SE2012/051367

§ 371 Date: Jun. 10, 2014

(30) Foreign Application Priority Data
Dec. 13, 2011 (SE) 1151190-4
Dec. 10, 2012 (SE) 1251395-8

(51) Int. Cl. F02M 65/00

(52) U.S. Cl. CPC F02M 65/003
USPC 73/114.51

(57) ABSTRACT

Method for error detection in a fuel-supply system includes determining (s410) a prevailing operating status in the engine (280), determining (s415) whether the determined operating status corresponds to a predetermined operating status, which operating status is regarded as stationary; continuously determining (s420) a progression in the fuel-supply pressure (P_rail) during the prevailing operating status; determining (s430) the number of occasions (N) within a specified period (DT) that the fuel-supply pressure (P_rail) alternately reaches a maximum or minimum value that deviates from a predetermined reference value (P_rail_ref) by more than a predetermined deviation value; and if the number of occasions (N) exceeds a specified value (TH), this indicates that the valve device (250) is not functioning as intended. Also a computer program product comprising program code (P) for a computer (200; 210) for implementing the method. Also a device and a motor vehicle equipped with the device.

### CROSS-REFERENCE TO RELATED APPLICATIONS

The present application is a 35 U.S.C. §§371 national phase conversion of PCT/SE2012/051367, filed Dec. 10, 2012, which claims priority of Swedish Patent Application No. 1151190-4, filed Dec. 13, 2011 and Swedish Patent Application No. 1251395-8, filed Dec. 10, 2012, the contents of which are incorporated by reference herein. The PCT International Application was published in the English language.

### TECHNICAL FIELD

The present invention relates to a method for error detection in a fuel-supply system in a motor vehicle comprising at least one feed device for achieving a fuel-supply pressure in an engine and a valve device via which fuel is supplied to the feed device from a container, in addition to devices for identifying said fuel-supply pressure in said engine. The invention relates also to a computer program product comprising program code for a computer for implementing a method according to the invention. The invention relates also to a device for error detection in a fuel-supply system in a motor vehicle and a motor vehicle equipped with the device.

### BACKGROUND

Modern motor vehicles may be equipped with a fuel system which has what is known as a common-rail. In this case, a low-pressure pump is adapted to suck up fuel from a fuel tank and feed the fuel through an IMV valve (Inlet metering valve) to a high-pressure pump. The high-pressure pump is adapted to pressurise the fuel by feeding the fuel to said common-rail for dispensing to a number of cylinders in the motor vehicle's engine. An MDV valve (Mechanical Dump Valve) is arranged on a return side of the fuel system which, when the fuel pressure in said common-rail is too high, functions as a pressure-relief valve allowing in this event a fuel flow back to the fuel tank.

A control unit in the fuel system is arranged to control said IMV valve by continuously detecting a prevailing pressure of the fuel in said common-rail and comparing this against a preferred reference value for the pressure of the fuel. This can typically be effected by means of a regulator intended for this purpose and a PWM signal. It is of the utmost importance that the IMV valve can be quickly regulated.

It is also important that transient progressions relating to the quantity of dispensed fuel in the engine's cylinders do not cause a fuel pressure in said common-rail to fall or rise.

This imposes strict requirements that the IMV valve will react almost immediately to control information in the PWM signal. A known problem associated with said IMV valve is what is known as “slip-stick”. This means that the valve is not able to alter a continuous fuel flow in the preferred manner.

There are a number of different possible sources for errors in the fuel system. For example, one of the feed pumps may fail. Alternatively, an unexpected leakage may occur, for example in fuel pipes or in said common-rail. At present, it is difficult to diagnose a source of error in the fuel system and troubleshooting is time-consuming. In some cases a correctly functioning unit may be needlessly replaced, which is both time-consuming and costly, especially if this fails to address the actual error.

At present, error code is generated in the event the fuel system does not function as intended. This error code is, however, rather general, which is why isolated fuel-system components may not be clearly identified as the likely source of the error. The error code generated at present is therefore not always helpful to a mechanic at a service station.

In this context, it should be noted that the IMV valve is a relatively cheap fuel-system component. It would therefore be advantageous to be able to isolate this particular component as the source of error in the event it fails to function as intended. With today's more general error codes, this may not always be possible.

DE102008044360 describes a fuel-injection system in an internal combustion engine of a motor vehicle. The fuel-injection system comprises a fuel tank, fuel pump, control valve, common-rail and a control unit. The control unit is adapted to control the control valve and regulate the fuel flow to said common-rail.

DE102006000483 describes a fuel-injection system in an internal combustion engine of a motor vehicle. The fuel-injection system comprises a fuel tank, a first fuel pump, control valve, a second fuel pump, common-rail and a control unit. The control unit is adapted to control the control valve and regulate the fuel flow to said second pump.

US20030084871 describes a fuel dispensing system which is relevant when describing an excess supply of fuel to a common-rail from a high-pressure pump. Said excess supply of fuel is caused in this case by a faulty IMV valve. In the event of said excess supply of fuel, a setting for the engine's target idling speed is modified.

### SUMMARY OF THE INVENTION

There is a need to be able to reliably identify a source of error in the fuel-supply system. It is particularly desirable to be able to isolate the IMV valve as the likely source of the error in the event that it does not satisfy the appropriate performance requirements, for example in a case where it begins to manifest excessive slip-stick.

The IMV valve can be controlled, for example, by a PWM signal. An open IMV valve means that fuel is released to the high-pressure pump which in turn means that the pressure in said common-rail increases. To lower the pressure, the fuel flow to the high-pressure pump may be choked off combined with the fuel leaving said common-rail as it is dispensed to the engine's cylinders. It is of the utmost importance that the preferred fuel pressure can be quickly regulated and that the pressure does not fall or rise in the event of sudden changes to the dispensed quantity of fuel. This imposes strict requirements that the IMV valve will react quickly to changes in the generated PWM signal. Slip-stick means that, in the event of a change in the PWM signal, the IMV valve's position is not immediately changed unless the change in the PWM signal is of major significance. The inventors of the present invention have found that when the IMV valve finally moves, the control error in the regulation system has been integrated, causing the IMV valve's position to move too far. The inventors of the present invention have found that this can cause major fluctuations in the fuel pressure. If the pressure is too high, this may cause the pressure-relief valve to open, generating an error code and restricting the engine's performance. An error code may also be generated if the pressure is too low and should the pressure become too low, this may cause the engine to stop. Said error codes for high and low pressure respectively do not however necessarily indicate that the IMV valve is seizing up (slip-stick). A number of different sources of errors in the fuel system are possible. To facilitate troubleshooting, the present invention proposes a diagnosis which clearly indicates that the IMV valve is faulty if such is the case.

One object of the present invention is to propose a novel and advantageous method for error detection in a fuel-supply system in a motor vehicle.

Another object of the invention is to propose a novel and advantageous device and a novel and advantageous computer program for error detection in a fuel-supply system in a motor vehicle.

A further object of the invention is to propose a method, a device and a computer program for precisely isolating a source of errors in a fuel system in a motor vehicle.

A further object of the invention is to propose a cost-effective method, device and computer program for error detection in a fuel supply system in a motor vehicle.

Another object of the invention is to propose an alternative method, a novel and advantageous device and a novel and advantageous computer program for error detection in a fuel-supply system in a motor vehicle.

These objects are achieved through a method for error detection in a fuel-supply system in a motor vehicle comprising a feed device for achieving a fuel-supply pressure in an engine and a valve device via which fuel is supplied to the feed device from a container in addition to devices for identifying said fuel-supply pressure in said engine as disclosed herein.

According to one aspect of the invention, a method is proposed for error detection in a fuel-supply system comprising a feed device for achieving a fuel-supply pressure in an engine and a valve device via which fuel is supplied to the feed device from a container in addition to devices for identifying said fuel-supply pressure in said engine, comprising the steps of:
determining a prevailing operating status in said engine:
determining whether said determined operating status corresponds to a predetermined operating status, which operating status is regarded as stationary;
continuously determining a progression in said fuel-supply pressure during said predetermined operating status. The method also comprises the steps of:
determining the number of occasions within a specified period said fuel-supply pressure alternately reaches a maximum or minimum value that deviates from a predetermined reference value by more than a predetermined deviation value;
if said number of occasions exceeds a specified value, taking this as an indication that said valve device is not functioning as intended.

The operating status can be determined on the basis of an engine speed and/or the quantity of fuel dispensed to the engine and/or the demand for a preferred pressure in a common-rail in the fuel supply system.

That said operating status is to be regarded as stationary means that said operating status is stationary or at least essentially stationary.

That said operating status is to be regarded as stationary means that said operating status is determined to be stationary or at least essentially stationary.

Said operating status may be considered stationary when the engine speed (n) and/or the quantity of fuel dispensed to the engine (280) is negligibly changed.

The fuel-supply system may be a common-rail-type system.

Said reference value may be determined on the basis of said predetermined operating status.

Said period may fall within a range of 10-50 seconds.

Said predetermined deviation value may be 20 bar or more.

The number of occasions may be a value within the range of 5-25 occasions.

When a prevailing operating status in said engine corresponds to a predetermined operating status, which operating status is regarded as stationary, only very small changes in the generated PWM need to be made to maintain the preferred fuel-supply pressure. Under these conditions, according to the method according to the invention, an IMW valve with slip-stick can be identified if the determined fuel-supply pressure manifests relatively powerful and relatively slow vibrations/oscillations. This is dependent on the initial negligible PWM changes not causing the IMV valve to move and also on the generated PWM increasing as the regulating error worsens. Ultimately the IMV valve “loosens” and as the control signal is integrated, this leads to fluctuations in the fuel-supply pressure. When the fuel-supply pressure is then regulated in the other direction, the corresponding phenomenon appears again. This causes the measured fuel pressure to have a relatively “sinus-shaped” appearance, i.e. an oscillating progression. Other types of error/sources of error, such as an excessively worn high-pressure pump, do not cause corresponding oscillations.

The method may further comprise the step of:
generating a predetermined error code at said indication.

The method may further comprise the step of:
controlling, after said indication, the oscillating motion of said valve device to avoid slip-stick. In this case, a control unit may be adapted to continuously control said valve device by means of a control signal to achieve a relatively high-frequency oscillating motion of the valve device. In the case, a valve in the valve device will not be in a constant position but rather oscillate around a predetermined position.

The method is simple to implement in existing motor vehicles. Software for error detection in a fuel-supply system in a motor vehicle comprising at least one feed device for achieving a fuel-supply pressure in an engine and a valve device via which fuel is supplied to the feed device from a container, in addition to devices for identifying said fuel-supply pressure in said engine according to the invention, can be installed in a control unit in the vehicle during the manufacture thereof. A purchaser of the vehicle may thus have the possibility of selecting the function of the method as an option. Alternatively, software which comprises program code for executing the innovative method for error detection in a fuel-supply system in a vehicle may be installed in a control unit of the vehicle on the occasion of upgrading at a service station. in which case the software may be loaded into a memory of the control unit. Implementation of the innovative method is thus cost-effective, particularly as, according to one aspect of the invention, no further components need to be installed in the vehicle. Necessary hardware is currently already provided in the vehicle. The invention therefore proposes a cost-effective solution to the problems stated above.

Software comprising program code for error detection in a fuel-supply system in a motor vehicle can be easily updated or replaced. Other components of the software can also be replaced independently of one another. This modular configuration is advantageous from a maintenance perspective.

According to one aspect of the invention, a device is proposed for error detection in a fuel-supply system in a motor vehicle comprising a feed device for achieving a fuel-supply pressure in an engine and a valve device via which fuel is supplied to the feed device from a container in addition to devices for identifying said fuel-supply pressure in said engine, comprising:
means for determining a prevailing operating status in said engine:
means for determining whether said determined operating status corresponds to a predetermined operating status, which operating status is regarded as stationary;
means for continuously determining a progression in said fuel-supply pressure during said predetermined operating status.
means for determining the number of occasions within a specified period said fuel-supply pressure alternately reaches a maximum or minimum value that deviates from a predetermined reference value by more than a predetermined deviation value; and
means, if the number of occasions exceeds a specified value, for taking this as an indication that said valve device is not functioning as intended.

The device may further comprise means for determining the operating status on the basis of an engine speed and/or the quantity of fuel dispensed to the engine and/or the demand for a preferred pressure in a common-rail in the fuel supply system.

The device may comprise a common-rail unit.

The device may comprise means for determining said reference value on the basis of said predetermined operating status.

The device may further comprise:
means for generating a predetermined error code at said indication.

The device may further comprise:
a further feed device which is arranged between said container and said valve device.

The device may further comprise a further valve device which can be used independently of said valve device. Said further valve device is already arranged in the immediate vicinity of said valve device. Said further valve device may be identical to said valve device. Said further valve device may be a backup valve device. A control unit in the fuel-supply system may be adapted to deactivate said valve device and activate said further valve device in the event that said valve device is not functioning as intended. In this case, said fuel may be conducted via said further valve device to the feed device from said container, instead of via said valve device.

The device may further comprise:
means for controlling, after said indication, the oscillating motion of said valve device to avoid slip-stick.

The foregoing object is also achieved with a motor vehicle comprising the characteristic device for error detection in a fuel-supply system. The motor vehicle may be a truck, bus or passenger car.

According to one aspect of the invention, a computer program is proposed for error detection in a fuel-supply system in a motor vehicle, which computer program comprises program code stored on a non-transitory or non-volatile computer-readable medium in order to cause an electronic control unit or another computer connected to the electronic control unit to perform the steps of the method disclosed herein.

According to an aspect of the invention, a computer program is proposed for error detection in a fuel-supply system in a motor vehicle, which computer program comprises program code for causing the electronic control unit or another computer connected to the electronic control unit to perform the steps of the method disclosed herein.

According to one aspect of the invention, a computer program product is proposed comprising a program code stored on a non-transitory computer-readable medium for performing the method steps disclosed herein, which computer program is run on an electronic control unit or another computer connected to the electronic control unit.

Further objects, advantages and novel features of the present invention will become apparent to one skilled in the art from the following details, and also by putting the invention into practice. Whereas the invention is described below, it should be noted that it is not limited to the specific details described. Specialists who have access to the teachings herein will recognise further applications, modifications and incorporations within other fields, which are within the scope of the invention.

### CONCISE DESCRIPTION OF THE DRAWINGS

For a more complete understanding of the present invention and further objects and advantages thereof, the detailed description set out below should be read together with the accompanying drawings, in which the same reference notations denote similar items in the various drawings, and in which:

FIG. 1 illustrates schematically a vehicle according to one embodiment of the invention;

FIG. 2 illustrates schematically a subsystem for the vehicle depicted in FIG. 1, according to one embodiment of the invention;

FIG. 3 illustrates schematically a diagram of a progression according to one aspect of the present invention;

FIG. 4a illustrates schematically a flowchart of a method according to one embodiment of the invention;

FIG. 4b illustrates schematically in more detail a flowchart of a method according to one embodiment of the invention; and

FIG. 5 illustrates schematically a computer according to one embodiment of the invention.

### DETAILED DESCRIPTION OF THE DRAWINGS

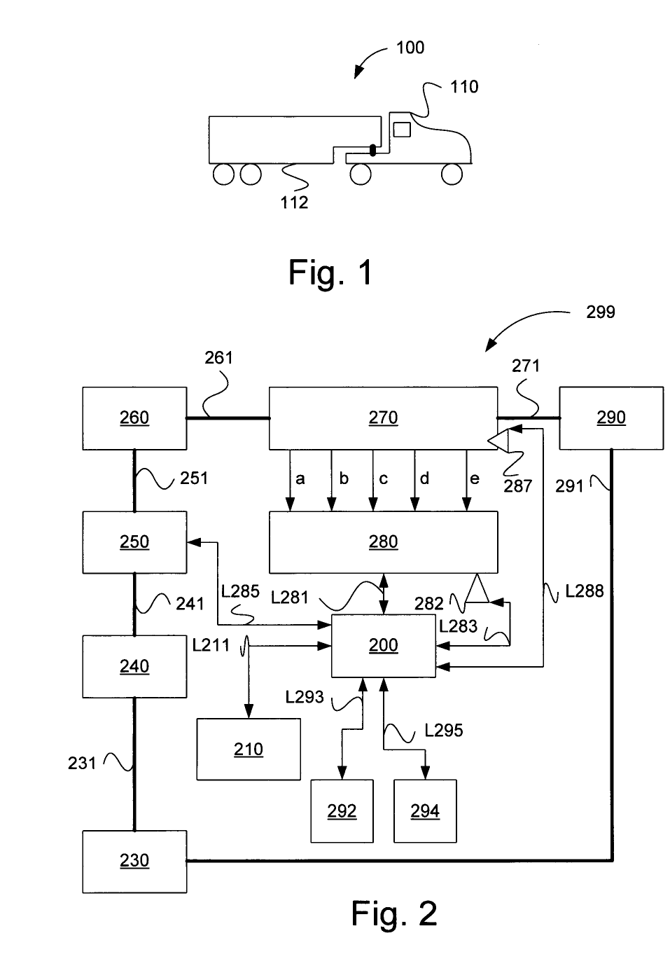

FIG. 1 depicts a side view of a vehicle 100. The exemplified vehicle 100 comprises a tractor unit 110 with a trailer 112. The vehicle may be a heavy vehicle, such as a truck or a bus. The vehicle may alternatively be a passenger car.

The term “link” refers herein to a communication link which may be a physical connection such as an opto-electronic communication line, or a non-physical connection such as a wireless connection, e.g. a radio link or microwave link.

FIG. 2 depicts a subsystem 299 of the vehicle 100. The subsystem 299 is arranged in a tractor unit 110. The subsystem 299 comprises a fuel tank 230 for holding, for example, diesel, ethanol or petrol. The tank 230 may be adapted to hold any appropriate volume, for example 1500 litres.

A low-pressure pump 240 is adapted to suck up fuel from the tank 230 via a first line 231. The low-pressure pump 240 is adapted to pressurise the fuel to approx. 8-12 bar. The low-pressure pump 240 is adapted to supply fuel to a valve device 250 via a second line 241.

The valve device 250 may comprise an IMV valve. The valve device 250 may be an electromechanical valve which can be controlled by a first control unit 200. The first control unit 200 is adapted to communicate with the valve device 250 via a link L285. The first control unit 200 is adapted to control the valve device 250 such that a fuel flow can thus be regulated. The valve device 250 may manifest what is known as slip-stick under certain circumstances, such as after a certain amount of wear, ageing or if undesirable particles are present in the fuel.

The valve device 250 is adapted to communicate flow to a high-pressure pump 260 via a third line 251. The high-pressure pump 260 is adapted to further pressurise the fuel and in this case feed the fuel to what is known as a common-rail unit 270 via a fourth line 261. Said common-rail unit 270 is adapted to hold said pressurised fuel. A pressure P_rail in the fuel present in said common-rail unit 270 may fall within a range of 500-3000 bar.

The fuel-supply system may comprise a further valve device (not depicted) which can be used independently of said valve device 250. Said further valve device may already be arranged in the immediate vicinity of said valve device 250. Said further valve device may be identical to said valve device 250. Said further valve device may a backup valve device. A control unit in the fuel-supply system may be adapted to deactivate said valve device 250 and activate said further valve device in the event that said valve device 250 is not functioning as intended. In this case, said fuel is conducted via said further valve device to the feed device from said container instead of via said valve device 250.

The common-rail unit 270 communicates flow to a pressure-relief valve 290 via a fifth line 271. The pressure-relief valve 290 may be what is known as an MDV valve. The pressure-relief valve 290 may be a mechanical valve which is adapted to be opened at least partially in the event of an abnormal or inadvertent high pressure in the fuel in said common-rail unit 270. The pressure-relief valve 290 is adapted to communicate flow to the fuel tank 230 via a sixth line 291.

Said common-rail unit 270 is adapted to supply fuel to cylinders in an engine 280 in the vehicle. According to one example, the engine 280 has five cylinders, a, b, c, d, e.

The first control unit 200 is adapted to communicate with the engine 280 via a link L281. The first control unit 200 is adapted to control the engine 280 by means of stored control routines.

A speed sensor 282 is already arranged in the engine 280. The speed sensor 282 is adapted to continuously determine a prevailing speed in the engine 280. The speed sensor 282 is adapted to communicate with the first control unit 200 via a link L283. The speed sensor 282 is adapted to continuously send signals containing information on a prevailing speed in the engine 280 to the first control unit 200 via the link L283.

A pressure sensor 287 is already arranged in the common-rail unit 270. The pressure sensor 287 is adapted to continuously determine a prevailing pressure P_rail in the fuel in said common-rail unit 270. The pressure sensor 287 is adapted to communicate with the first control unit 200 via a link L288. The pressure sensor 287 is adapted to continuously send signals containing information on a prevailing pressure P_rail to the first control unit 200 via the link L288.

The first control unit 200 is adapted to continuously determine a quantity of fuel dispensed to the engine 280. This means continuously determining a prevailing fuel quantity dispensed to the engine 280. This may be effected on the basis of an acceleration demanded by means of an accelerator pedal 292. The accelerator pedal 292 is adapted to continuously send signals containing information on acceleration demanded by a driver to the first control unit 200 via a link L283.

The first control unit 200 may be further adapted to control, after said indication, the oscillating motion of said valve device to avoid slip-stick.

A display screen 294 may be arranged in a cab in the vehicle 100. The first control unit 200 is adapted to communicate with the display screen 294 via a link L295. The display screen is adapted to indicate to a driver, where appropriate, that the valve device 250 is not functioning as intended.

According to one embodiment, the first control unit 200 is adapted to determine a reference value P_rail_ref for said prevailing pressure P_rail. This may be effected on the basis of an acceleration demanded by means of the accelerator pedal 292. The accelerator pedal 292 is adapted to continuously send signals containing information on acceleration demanded by a driver to the first control unit 200 via the link L293.

According to one embodiment, the first control unit is adapted to:
determine a prevailing operating status in said engine 280:
determine whether said determined operating status corresponds to a predetermined operating status, which operating status is regarded as stationary;
continuously determine a progression in said fuel-supply pressure P_rail during said predetermined operating status;
determine the number of occasions N within a specified period DT said fuel-supply pressure P_rail alternately reaches a maximum or minimum value that deviates from a predetermined reference value P_rail_ref by more than a predetermined deviation value;
if the number of occasions N exceeds a specified value TH, take this as an indication that said valve device 250 is not functioning as intended.

A second control unit 210 is adapted to communicate with the first control unit 200 via a link L211. The second control unit 210 may be detachably connected to the first control unit 200. The second control unit 210 may be a control unit external to the vehicle 100. The second control unit 210 may be adapted to perform the innovative method steps according to the invention. The second control unit 210 may be used to transfer software to the first control unit 200, particularly software for implementing the innovative method. The second control unit 210 may alternatively be adapted to communicate with the first control unit 200 via an internal network in the vehicle. The second control unit 210 may be adapted to perform essentially the same functions as the first control unit 200, for example determining the number of occasions within a specified period a progression in the fuel-supply pressure in the common-rail unit alternately reaches a maximum or minimum value which to a specified extent deviates from a predetermined reference value and, if said number of occasions exceeds a specified value, taking this as an indication that an IMV valve in the fuel supply system is not functioning as intended.

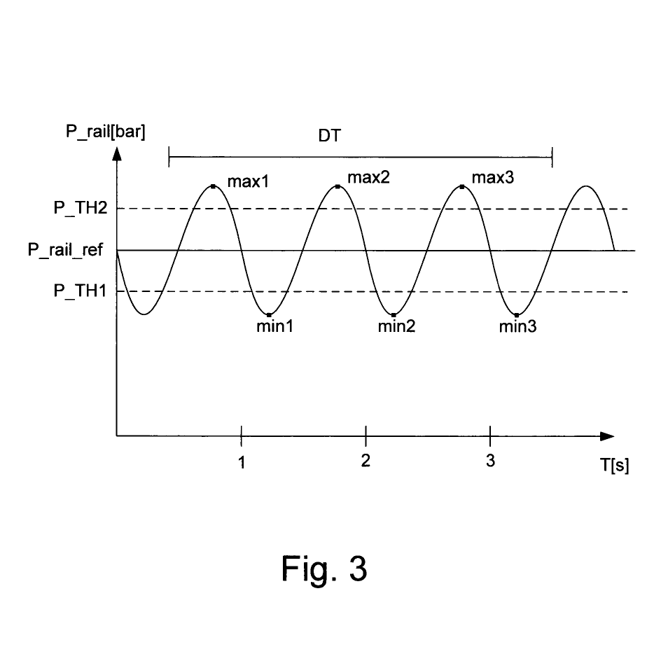

FIG. 3 illustrates schematically a diagram which describes a progression in the detected pressure P_rail in the fuel in the common-rail unit 270. According to this progression, the valve device 250 is manifesting what is known as slip-stick.

The diagram shows a reference level P_rail_ref for the pressure in the fuel in the common-rail unit 270. This reference level can be determined by means of the first control unit 200. This reference level corresponds to a preferred reference value for the pressure in the fuel in the common-rail unit 270.

This illustrates how the pressure P_rail varies with the time T. In cases where the valve device 250 manifests slip-stick, the pressure P_rail will assume an essentially sinus-shaped curve, as illustrated in FIG. 3.

According to one aspect of the invention, the threshold values P_TH1 and P_TH2 are provided. Said threshold values may be determined to correspond to a pressure P_TH1=P_rail-20 bar and P_TH2=P_rail+20 bar respectively. According one alternative, said threshold values P_TH1 and P_TH2 are defined in any appropriate way.

According to one aspect of the invention, a number of occasions N on which the maximum values and minimum values of the curve representing the pressure P_rail exceed or fall below said threshold values P_TH1 and P_TH2 respectively during a predetermined period of time DT is determined.

According to this example, the number of occasions N is determined for the value 6, namely for the determined minimum and maximum values max1, max2, max3, min1, min2 and min3. These values exceed or fall below said threshold values P_TH1 and P_TH2.

The determined number of occasions N can then be compared to a predetermined value TH. According to this example, TH may be 3. As the determined number of occasions N exceeds TH, it can be determined that the valve device 250 is not functioning as intended (due to slip-stick).

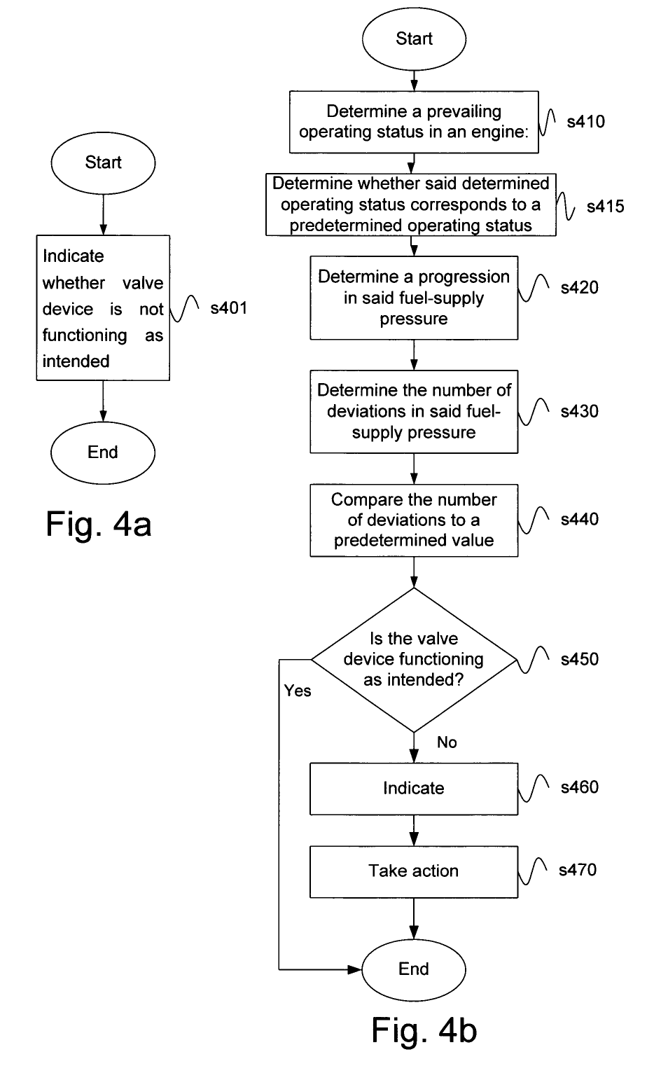

FIG. 4a illustrates schematically a flowchart of a method for error detection in a fuel-supply system in a motor vehicle comprising at least one feed device for achieving a fuel-supply pressure in an engine and a valve device via which fuel is supplied to the feed device from a container, in addition to devices for identifying said fuel-supply pressure in said engine, according to one embodiment of the invention. The method comprises a first method step s401. The step s401 comprises the step of
determining whether a determined operating status prevails in said engine, which operating status is regarded as stationary;
continuously determining a progression in said fuel-supply pressure during said determined operating status.
determining the number of occasions within a specified period the progression in said fuel-supply pressure alternately reaches a maximum or minimum value which to a specified extent deviates from a predetermined reference value;
if the number of occasions exceeds a specified value, taking this as an indication that said valve device is not functioning as intended. The method ends after step s401.

FIG. 4b illustrates schematically a flowchart of a method for error detection in a fuel-supply system in a motor vehicle comprising at least one feed device for achieving a fuel-supply pressure in an engine and a valve device via which fuel is supplied to the feed device from a container, in addition to devices for identifying said fuel-supply pressure in said engine, according to one embodiment of the invention.

The method comprises a first method step s410. Method step s410 comprises the step of determining a prevailing operating status in said engine: The operating status may, for example, be determined on the basis of an engine speed and/or the quantity of fuel dispensed to the engine and/or the demand for a preferred pressure in a common-rail 270 in the fuel supply system. After the method step s410, a subsequent method step s415 is performed.

The method step s415 comprises the step of determining whether said determined operating status corresponds to a predetermined operating status, which operating status is regarded as stationary; the operating status may be regarded as stationary when the engine speed in the engine and/or the fuel supply to the engine is negligibly changed. According to one example, the engine speed in the engine may be regarded as negligibly changed when this is not changed by more than +/−50 rpm during a predetermined period of time. According to one example, the engine speed in the engine may be regarded as negligibly changed when this is not changed by more than +/−20 rpm during a predetermined period of time. According to one example, the fuel supply to the engine may be regarded as negligibly changed when this is not changed by more than +/−20 rpm during a predetermined period of time. After the method step s415, a subsequent method step s420 is performed.

The method step s420 comprises the step of continuously determining a progression in said fuel-supply pressure P_rail during said determined operating status. In this case, the pressure sensor 287 may continuously detect a prevailing pressure in the fuel in said common-rail 270. After the method step s420, a subsequent method step s430 is performed.

The method step s430 comprises the step of determining the number of occasions N within a specified period DT said fuel-supply pressure P_rail alternately reaches a maximum or minimum value (e.g. max1, min1, max2, min2, max3, min3) that deviates from a predetermined reference value P_rail_ref by more than a predetermined deviation value. Said period DT may, for example, be 30 seconds. Said period DT may be shorter than 30 seconds. Said period DT may be longer than 30 seconds. Said maximum or minimum values are defined herein as the maximum values or minimum values of periodic oscillations in said continuously determined progression in said fuel-supply pressure P_rail. Each occasion a maximum or minimum value exceeds or falls below P_TH2 and P_TH1 described above, this is registered for an accumulated calculation of the number of occasions during said specified period DT. After the method step s430, a subsequent method step s440 is carried out.

The method step s440 comprises the step of comparing the number of determined deviations according to step s430 with a predetermined value. Said predetermined value may be any appropriate value TH, for example 3 or 10, depending on the determined progression's frequency F and said specified period DT. After the method step s440, a subsequent method step s450 is performed.

The method step s450 comprises the step of determining whether the valve device 240 is functioning as intended. If said determined number of occasions exceeds said appropriate value TH, it may be determined that the valve device 240 is not functioning as intended. If said determined number of occasions falls below said appropriate value TH, it may be determined that the valve device 240 is functioning as intended. If it is determined that the valve device 240 is not functioning as intended, i.e. no, a subsequent method step s460 is performed. If it is determined that the valve device 240 is functioning as intended, i.e. yes, the method ends.

The method step s460 comprises the step of indicating that said valve device 240 is not functioning as intended. This can be effected visually by means of a display screen arranged in the driver's cab. According to one embodiment, an error code is generated in the first control unit 200, which code indicates that the valve device 250 is not functioning as intended. After the method step s460, a subsequent method step s470 is performed.

The method step s470 comprises the step of performing an action. This method step is optional. Said action may be any appropriate action. Said action may comprise changing a prevailing operating mode in the first control unit 200 to a different appropriate operating mode, for example a limp-home operating mode. The method ends after the method step s470.

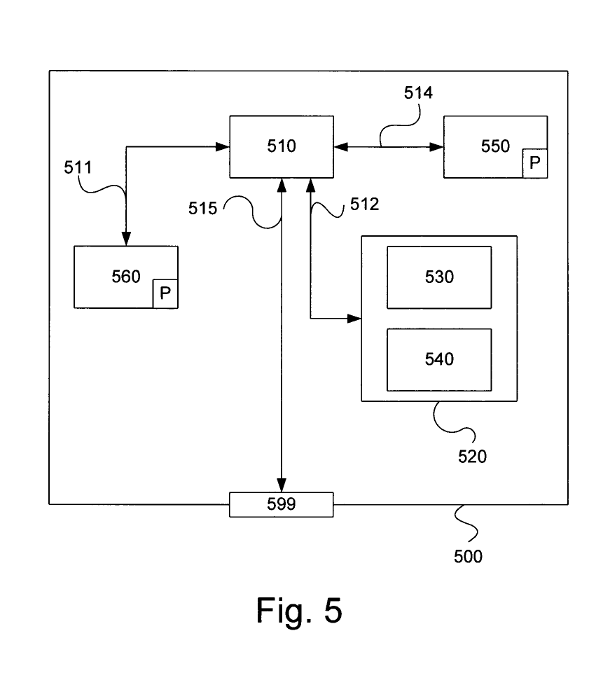

FIG. 5 depicts a diagram of an embodiment of a device 500. In one embodiment, the control units 200 and 210 described with reference to FIG. 2 may comprise the device 500. The device 500 comprises a non-volatile memory 520, a data processing unit 510 and a read/write memory 550. The non-volatile memory 520 has a first memory element 530 in which a computer program, e.g. an operating system, is stored for controlling the function of the device 500. The device 500 further comprises a bus controller, a serial communication port, I/O means, an ND converter, a time and date input and transmission unit, an event counter and an interruption controller (not depicted). The non-volatile memory 520 has also a second memory element 540.

In this case, a computer program P is proposed comprising routines for:
determining a prevailing operating status in said engine:
determining whether said determined operating status corresponds to a predetermined operating status, which operating status is regarded as be stationary;
continuously determining a progression in said fuel-supply pressure during said predetermined operating status.
determining the number of occasions within a specified period said fuel-supply pressure alternately reaches a maximum or minimum value that deviates from a predetermined reference value by more than a predetermined deviation value;
if the number of occasions exceeds a specified value, taking this as an indication that said valve device is not functioning as intended.

According to one embodiment, the program P comprises routines for determining the operating status on the basis of an engine speed in the engine 230 and/or the quantity of fuel dispensed to the engine and/or the demand for the preferred pressure in a common-rail in the fuel supply system.

According to one embodiment, the program P comprises routines for generating a predetermined error code at said indication.

According to one embodiment, the program P comprises routines for activating a further valve device and deactivating the valve device 250 at said indication. In this case, an incorrectly functioning valve device may be replaced by a backup valve device.

According to one embodiment, the program P comprises routines for controlling, after said indication, the oscillating motion of said valve device 250 to avoid slip-stick.

The program P may be stored in an executable form or compressed form in a memory of 560 and/or in a read/write memory 550.

Where it is stated that the data processing unit 510 performs a certain function, it means that the data processing unit 510 effects a certain part of the program which is stored in the memory 560 or a certain part of the program which is stored in the read/write memory 550.

The data processing device 510 may communicate with a data port 599 via a data bus 515. The non-volatile memory 520 is intended for communication with the data processing unit 510 via a data bus 512. The separate memory 560 is intended to communicate with the data processing unit 510 via a data bus 511. The read/write memory 550 is adapted to communicate with the data processing unit 510 via a data bus 514. The links, for example L211, L281, L283, L288, L293 and L295, may be connected to the data port 599 (see FIG. 2).

When data are received on the data port 599, they are stored temporarily in the second memory element 540. When input data received have been temporarily stored, the data processing unit 510 will be ready to effect code execution in a manner described above. According to one embodiment, signals received on the data port 599 contain information on a prevailing fuel pressure P_rail in the common-rail unit 270. According to one embodiment, signals received on the data port 599 contain information on a prevailing speed in the vehicle's engine. According to one embodiment, the data processing device 500 comprises routines for continuously determining a prevailing quantity of fuel dispensed to the engine from the common-rail unit 270. According to one embodiment, the data processing device 500 comprises routines for continuously determining a demand for the preferred pressure P-rail in said common-rail 270 in the fuel-supply system.

Parts of the methods herein described may be effected by the device 500 by means of the data processing unit 510 which runs the program stored in the memory 560 or the read/write memory 550. When the device 500 runs the program, methods herein described are executed.

The foregoing description of the preferred embodiments of the present invention is provided for illustrative and descriptive purposes. It is not intended to be exhaustive or to limit the invention to the variants described. Many modifications and variants will obviously be apparent to one skilled in the art. The embodiments have been chosen and described in order best to make clear the principles of the invention and its practical applications and hence to make it possible for one skilled in the art to understand the invention for various embodiments and with the various modifications appropriate to the intended use.

1. A method for error detection in a fuel-supply system, wherein the fuel supply system comprises a feed device for achieving a fuel-supply pressure (P-rail) in an engine and a valve device via which fuel is supplied to the feed device and devices for identifying the fuel-supply pressure (P_rail) in the engine;
the method comprising the steps of:
determining a prevailing operating status in the engine:
determining whether the determined operating status corresponds to a predetermined operating status, which operating status is regarded as stationary;
continuously determining a progression in the fuel-supply pressure (P_rail) during the predetermined operating status;
determining the number of occasions (N) within a specified time period (DT) when the fuel-supply pressure (P_rail) alternately reaches a maximum or a minimum value (max1, min1, max2, min2, max3, min3) that deviates from a predetermined reference value (P_rail_ref) by more than a predetermined deviation value and;
if the number of occasions (N) exceeds a specified value (TH), taking this as an indication that the valve device is not functioning as intended and this is an error detected.

2. The method according to claim 1, further comprising basing the determining of the operating status based on an engine speed (n) and/or a quantity of fuel dispensed to the engine and/or a demand for the preferred pressure (P_rail_ref) in a common-rail in the fuel supply system.

3. The method according to claim 1, further comprising regarding the operating status as stationary when the engine speed (n) and/or the quantity of fuel dispensed to the engine is negligibly changed.

4. The method according to claim 1, wherein the fuel-supply system is a common-rail-type system.

5. The method according to claim 1, further comprising determining the reference value (P_rail_ref) based on the predetermined operating status.

6. The method according to claim 1, wherein the time period (DT) falls within a range of 10-50 seconds.

7. The method according to claim 1, wherein the predetermined deviation value is at least 20 bar.

8. The according to claim 1, wherein the number of occasions (N) falls within the range of 5-25 occasions.

9. The method according to claim 1, further comprising the step of:
generating a predetermined error code at the indication that the valve device is not functioning.

10. The method according to claim 1, wherein the valve device operates in an oscillating motion,
the method further comprising the step of:
after the indication, controlling the oscillating motion of the valve device.

11. An error detection device for error detection in a fuel-supply system, wherein the fuel-supply system comprises a feed device for achieving a fuel-supply pressure (P-rail) in an engine and a valve device via which fuel is supplied to the feed device and devices for identifying the fuel-supply pressure in the engine;
the error detection device comprising:
a device for determining a prevailing operating status in the engine:
the device being configured for further determining whether the determined operating status corresponds to a predetermined operating status, which operating status is regarded as stationary;
the device being configured for further continuously determining a progression in the fuel-supply pressure (P_rail) during the predetermined operating status.
the device being configured for further determining the number of occasions (N) within a specified time period (DT) when the fuel-supply pressure (P_rail) alternately reaches a maximum or minimum value (max1, min1, max2, min2, max3, min3) that deviates from a predetermined reference value (P_rail_ref) by more than a predetermined deviation value; and
if the number of occasions (N) exceeds a specified value (TH), the device being configured for taking the exceeding as an indication that the valve device is not functioning as intended.

12. The device according to claim 11, further comprising the device being configured for further determining the operating status based on an engine speed (n), and/or a quantity of fuel dispensed to the engine and/or a demand for a preferred pressure (P_rail_ref) in a common-rail in the fuel supply system.

13. The device according to claim 11, wherein the operating status is regarded as stationary based on the engine speed (n) and/or a quantity of fuel dispensed to the engine is negligibly changed.

14. The device according to claim 11, wherein the fuel-supply system is a common-rail-type system.

15. The device according to claim 11, further comprising the device being configured for further determining the reference value (P_rail-ref) based on the predetermined operating status.

16. The device according to claim 11, wherein the time period (DT) falls within a range of 10-50 seconds.

17. The device according to claim 11, wherein the predetermined deviation value is at least 20 bar.

18. The device according to claim 11, wherein the number of occasions (N) falls within the range of 5-25 occasions.

19. The device according to claim 11, further comprising:
the device being configured for generating a predetermined error code at the indication that the valve is not functioning.

20. The device according to claim 11, further comprising:
a further feed device which is arranged between the container and the valve device.

21. The device according to claim 11, further comprising:
a further valve device which is configured to be used independently of the valve device.

22. The device according to claim 11, further comprising:
after the indication, the device being configured for controlling the oscillating motion of the valve device.

23. A motor vehicle comprising a device according to claim 11.

24. A motor vehicle according to claim 23, comprising one from among a truck, bus or passenger car.

25. (canceled)

26. A computer program product for error detection in a fuel-supply system in a motor vehicle comprising: a computer program code stored on a non-transitory and non-volatile computer-readable medium, the program code being configured and operable for causing an electronic control unit or another computer connected to the electronic control unit to perform the method steps according to claim 1.
